(19) United States
(12) Patent Application Publication
(10) Pub. No.: US 2026/0173163 A1
(43) Pub. Date: Jun. 18, 2026

(54) SYSTEM AND METHOD FOR IMMW WIRELESS COMMUNICATIONS

(71) Applicant: NXP USA, Inc., AUSTIN, TX (US)

(72) Inventors: Liwen Chu, San Ramon, CA (US); Rui Cao, Sunnyvale, CA (US); Xiayu Zheng, San Jose, CA (US); Hongyuan Zhang, Fremont, CA (US)

(21) Appl. No.: 19/418,011

(22) Filed: Dec. 12, 2025

Related U.S. Application Data
(60) Provisional application No. 63/733,384, filed on Dec. 12, 2024.
(60) Provisional application No. 63/738,941, filed on Dec. 26, 2024.

(51) Int. Cl. H04W 74/0833; H04L 5/00; H04W 28/02; H04W 74/0816

(52) U.S. Cl. CPC H04W 74/085; H04L 5/0053; H04W 28/0278; H04W 74/0816

(57) ABSTRACT

Embodiments of a method and apparatus for wireless communications are disclosed. In an embodiment, a wireless device includes a controller configured to perform a backoff procedure before a transmit opportunity (TXOP) for frame exchanges in an integrated millimeter wave (IMMW) link and to perform TXOP protection at a beginning of the TXOP and a wireless transceiver configured to conduct the frame exchanges in the IMMW link during the TXOP.

### CROSS-REFERENCE TO RELATED APPLICATIONS

This application is entitled to the benefit of U.S. Provisional Patent Application Ser. No. 63/733,384, filed on Dec. 12, 2024 and U.S. Provisional Patent Application Ser. No. 63/738,941, filed on Dec. 26, 2024, the contents of each of which are incorporated by reference herein in their entireties.

### SUMMARY

Embodiments of a method and apparatus for wireless communications are disclosed. In an embodiment, a wireless device includes a controller configured to perform a backoff procedure before a transmit opportunity (TXOP) for frame exchanges in an integrated millimeter wave (IMMW) link and to perform TXOP protection at a beginning of the TXOP and a wireless transceiver configured to conduct the frame exchanges in the IMMW link during the TXOP. Other embodiments are also disclosed.

In an embodiment, the wireless device includes an IMMW wireless access point (AP) associated with an AP multi-link device (MLD), and the IMMW link is established between the AP MLD and a non-AP station (STA) MLD.

In an embodiment, the wireless device includes an IMMW non-access point (AP) station (STA) associated with a non-AP STA multi-link device (MLD), and the IMMW link is established between the non-AP STA MLD and an AP MLD.

In an embodiment, the backoff procedure includes an Enhanced Distributed Channel Access (EDCA) backoff procedure.

In an embodiment, a single access category (AC)'s backoff is used in the EDCA backoff procedure.

In an embodiment, the controller is further configured to define a single network allocation vector (NAV) timer for a virtual carrier sensing of the EDCA backoff procedure.

In an embodiment, the controller is further configured to define a duplicate Physical Layer Protocol Data Unit (PPDU) to perform the TXOP protection.

In an embodiment, a request to send (RTS) and a clear to send (CTS), a multi-user (MU)-RTS and CTS, or a Buffer Status Report polling (BSRP) non-trigger based (NTB) frame and a Multi-station (STA) block acknowledgement (BA) at a beginning of the TXOP for the TXOP protection are carried in the duplicate PPDU.

In an embodiment, an acknowledgment (Ack) and a block Ack (BA) for the TXOP protection are carried in the duplicate PPDU to acknowledge a soliciting MAC Protocol Data Unit (MPDU) and an Aggregated MAC Protocol Data Unit (A-MPDU), respectively.

In an embodiment, frame exchanges between an IMMW access point (AP) and an IMMW station (STA) are within a negotiated service period (SP), and the frame exchanges ends at an end time of the negotiated SP or before the end time of the negotiated SP if there is no further frame to transmit and receive.

In an embodiment, outside a service period (SP), an IMMW access point (AP) and an IMMW station (STA) are not available.

In an embodiment, after the IMMW AP or the IMMW STA becomes available, the IMMW AP or the IMMW STA monitors a wireless medium for a pre-defined time, and if the wireless medium is idle within the pre-defined time, the IMMW AP or the IMMW STA starts to count down its backoff counter.

In an embodiment, a wireless AP MLD includes a controller configured to perform an Enhanced Distributed Channel Access (EDCA) backoff procedure before a transmit opportunity (TXOP) for frame exchanges in an integrated millimeter wave (IMMW) link and to perform TXOP protection at a beginning of the TXOP and a wireless transceiver configured to conduct the frame exchanges in the IMMW link with a non-AP station (STA) MLD during the TXOP.

In an embodiment, a method for wireless communications involves at a wireless device, performing a backoff procedure before a transmit opportunity (TXOP) for frame exchanges in an integrated millimeter wave (IMMW) link, at the wireless device, performing TXOP protection at a beginning of the TXOP, and at the wireless device, conducting the frame exchanges in the IMMW link during the TXOP.

In an embodiment, the wireless device includes an IMMW wireless access point (AP) associated with an AP multi-link device (MLD), and the IMMW link is established between the AP MLD and a non-AP station (STA) MLD.

In an embodiment, the wireless device includes an IMMW non-access point (AP) station (STA) associated with a non-AP STA multi-link device (MLD), and the IMMW link is established between the non-AP STA MLD and an AP MLD.

In an embodiment, the backoff procedure includes an Enhanced Distributed Channel Access (EDCA) backoff procedure.

In an embodiment, a single access category (AC)'s backoff is used in the EDCA backoff procedure.

In an embodiment, performing the backoff procedure includes at the wireless device, defining a single network allocation vector (NAV) timer for a virtual carrier sensing of the EDCA backoff procedure.

In an embodiment, performing the TXOP protection includes at the wireless device, defining a duplicate Physical Layer Protocol Data Unit (PPDU) to perform the TXOP protection.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with an embodiment of the disclosure.

FIG. 3 depicts a multi-link (ML) communications system in accordance with example embodiments.

FIG. 4 depicts a wireless device in accordance with example embodiments.

FIG. 5 illustrates an exchange in duplicate Physical Layer Protocol Data Units (PPDUs) in accordance with example embodiments.

FIG. 6 is a process flow diagram of a method for wireless communications in accordance with example embodiments.

Throughout the description, similar reference numbers may be used to identify similar elements.

### DETAILED DESCRIPTION

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

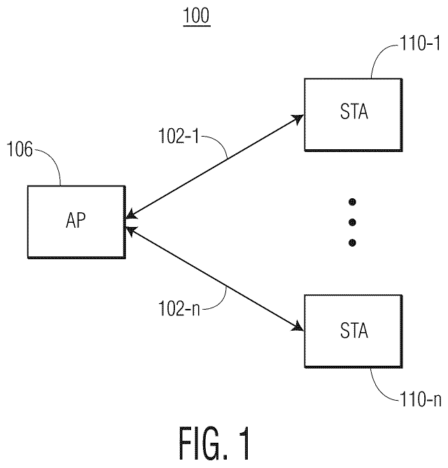

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). In some embodiments, the AP 106 (e.g., a controller or a transceiver of the AP) does not implement upper layer MAC functionalities (e.g., beacon, association establishment, reordering of frames, etc.) where the upper layer MAC functionalities are implemented by the other APs affiliated with the same AP MLD as the AP 106, but the AP 106 implements the lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 5 gigahertz (GHz) frequency band and another AP may operate in a 60 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an IMMW (integrated milli-meter wave) (Institute of Electrical and Electronics Engineer (IEEE) 802.11bq) communication protocol in one link with the help of at least another protocol in another link, e.g. an Ultra High Reliability (UHR) communication protocol, or an IEEE 802.11 communication protocol (e.g., an IEEE 802.11bn communication protocol). In some embodiments of the wireless communications system described herein, different associated STAs within range of an AP operating according to the IMMW communication protocol.

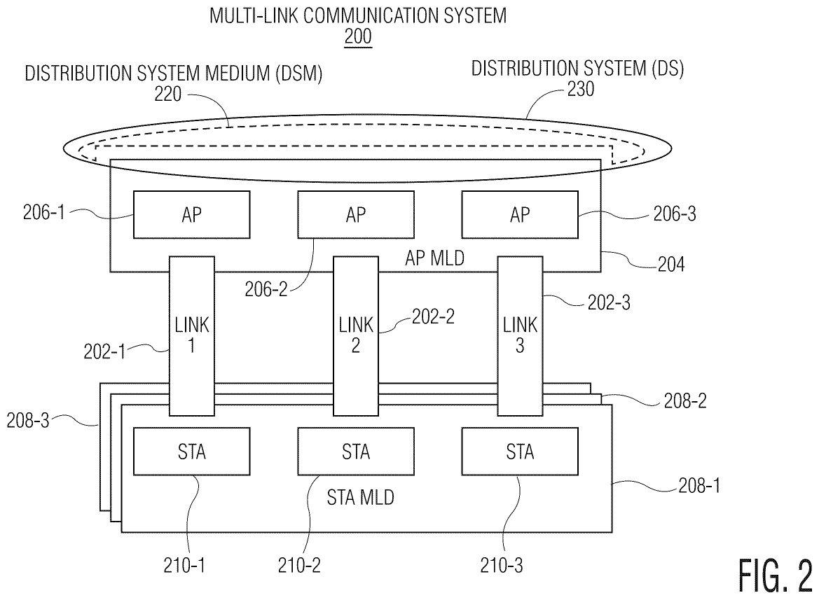

FIG. 2 depicts a multi-link (ML) communications system 200 that is used for wireless (e.g., WiFi) communications in accordance with example embodiments. In the embodiment depicted in FIG. 2, the multi-link communications system includes at least one AP multi-link device (MLD) 204, and one or more non-AP multi-link devices, which are, for example, implemented as station (STA) MLDs 208-1, 208-2, 208-3. The multi-link communications system can be used in various applications, such as industrial applications, medical applications, computer applications, and/or consumer or appliance applications. In some embodiments, the multi-link communications system is a wireless communications system, such as a wireless communications system compatible with an Institute of Electrical and Electronics Engineers (IEEE) 802.11 protocol. Although the depicted multi-link communications system 200 is shown in FIG. 2 with certain components and described with certain functionality herein, other embodiments of the multi-link communications system 200 may include fewer or more components to implement the same, less, or more functionality. For example, although the multi-link communications system 200 is shown in FIG. 2 includes the AP MLD 204 and the STA MLDs 208-1, 208-2, 208-3, in other embodiments, the multi-link communications system includes other multi-link devices, such as, multiple AP MLDs and multiple STA MLDs, multiple AP MLDs and a single STA MLD, a single AP MLD and a single STA MLD. In another example, in some embodiments, the multi-link communications system includes more than three STA MLDs and/or less than three STA MLDs. In yet another example, although the multi-link communications system 200 is shown in FIG. 2 as being connected in a certain topology, the network topology of the multi-link communications system 200 is not limited to the topology shown in FIG. 2.

In the embodiment depicted in FIG. 2, the AP MLD 204 includes three APs in three links, implemented as APs 206-1, 206-2, 206-3. In some embodiments, the AP MLD 204 is an AP multi-link logical device or an AP multi-link logical entity (MLLE). In some embodiments, a common part of the AP MLD 204 implements upper layer Media Access Control (MAC) functionalities common to multiple links (e.g., association establishment, reordering of frames, etc.) and a link specific part of the AP MLD 204, i.e., the APs 206-1, 206-2, 206-3, implement the upper layer MAC functionalities specific to a link and the lower layer MAC functionalities (e.g., beaconing, backoff, frame transmission, frame reception, etc.). The APs 206-1, 206-2, 206-3 may be implemented in hardware (e.g., circuits), software, firmware, or a combination thereof. At least one of the APs 206-1, 206-2, 206-3 may be fully or partially implemented as an integrated circuit (IC) device. In some embodiments, the APs 206-1, 206-2, 206-3 are compatible with at least one wireless local area network (WLAN) communications protocol (e.g., at least one IEEE 802.11 protocol). For example, the APs 206-1, 206-2, 206-3 may be wireless APs compatible with at least one IEEE 802.11bq protocol or IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., the AP 206-1, the AP 206-2, and/or the AP 206-3) includes at least one antenna, at least one transceiver operably connected to the at least one antenna, and at least one controller operably connected to the corresponding transceiver. In some embodiments, one AP, e.g., in an mmWave (IMMW) link, is integrated with at least the another AP, e.g., in a non-mmWave (<=7 GHz) link where the MLD association etc. are only preformed in the non-IMMW (<=7 GHz) link. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1, 206-2, 206-3 of the AP MLD 204 operates in a different BSS operating channel. For example, at least one of the APs 206-1, 206-2, 206-3 of the AP MLD 204 operates in an Extremely High Frequency (EHF) band or the “millimeter wave (mmWave)” frequency band. In some embodiments, the mmWave frequency band is a frequency band between 20 Gigahertz (GHz) and 300 GHz. For example, the mmWave frequency band is a frequency band above 45 GHz, e.g., a 60 GHz frequency band. For example, the AP 206-1 may operate at 6 Gigahertz (GHz) band (e.g., in a 320 MHz (one million hertz) Basic Service Set (BSS) operating channel or other suitable BSS operating channel), the AP 206-2 may operate at 5 GHz band (e.g., a 160 MHz BSS operating channel or other suitable BSS operating channel), and the AP 206-3 may operate at 60 GHz band (e.g., a 160 MHz BSS operating channel or other suitable BSS operating channel). In the embodiment depicted in FIG. 2, the AP MLD is connected to a distribution system (DS) 230 through a distribution system medium (DSM) 220. The distribution system (DS) 230 may be a wired network or a wireless network that is connected to a backbone network such as the Internet. The DSM 220 may be a wired medium (e.g., Ethernet cables, telephone network cables, or fiber optic cables) or a wireless medium (e.g., infrared, broadcast radio, cellular radio, or microwaves). Although the AP MLD 204 is shown in FIG. 2 as including three APs, other embodiments of the AP MLD 204 may include fewer than three APs or more than three APs. In addition, although some examples of the DSM 220 are described, the DSM 220 is not limited to the examples described herein.

In the embodiment depicted in FIG. 2, the STA MLD 208-1 includes multiple non-AP stations (STAs) 210-1, 210-2, 210-3. The STAs 210-1, 210-2, 210-3 may be implemented in hardware (e.g., circuits), software, firmware, or a combination thereof. The STAs 210-1, 210-2, 210-3 may be fully or partially implemented as an IC device. In some embodiments, the non-AP STAs 210-1, 210-2, 210-3 are part of the STA MLD 208-1, such that the STA MLD may be a communications device that wirelessly connects to a wireless AP MLD, such as, the AP MLD 204. For example, the STA MLD 208-1 (e.g., at least one of the non-AP STAs 210-1, 210-2, 210-3) may be implemented in a laptop, a desktop personal computer (PC), a mobile phone, or other communications device that supports at least one WLAN communications protocol. In some embodiments, the non-AP STA MLD 208-1 is a communications device compatible with at least one IEEE 802.11 protocol (e.g., an IEEE 802.11 bq protocol, an IEEE 802.11 bn protocol, an IEEE 802.11be protocol, an IEEE 802.11ax protocol, or an IEEE 802.11ac protocol). In some embodiments, each of the non-AP STAs 210-1, 210-2, 210-3 includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. In some embodiments, the STA MLD has one MAC data service interface. In an embodiment, a single address is associated with the MAC data service interface and is used to communicate on the DSM 220. In some embodiments, the STA MLD 208-1 implements a common MAC data service interface and the non-AP STAs 210-1, 210-2, 210-3 implement a lower layer MAC data service interface. In some embodiments, the AP MLD 204 and/or the STA MLDs 208-1, 208-2, 208-3 identify which communications links support the multi-link operation during a multi-link operation setup phase and/or exchanges information regarding multi-link capabilities during the multi-link operation setup phase. Each of the STAs 210-1, 210-2, 210-3 of the STA MLD may operate in a different frequency band. For example, at least one of the STAs 210-1, 210-2, 210-3 of the STA MLD 208-1 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. For example, the STA 210-1 may operate at 6 GHz band (e.g., in a 320 MHz (one million hertz) BSS operating channel or other suitable BSS operating channel), the STA 210-2 may operate at 5 GHz band (e.g., a 160 MHz BSS operating channel or other suitable BSS operating channel), and the STA 210-3 may operate at 60 GHz band (e.g., a 160 MHz BSS operating channel or other suitable BSS operating channel). Although the STA MLD 208-1 is shown in FIG. 1 as including three non-AP STAs, other embodiments of the STA MLD 208-1 may include fewer than three non-AP STAs or more than three non-AP STAs.

Each of the MLDs 208-2, 208-3 may be the same as or similar to the MLD 208-1. For example, the MLD 208-2 or 208-3 includes multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver.

In the embodiment depicted in FIG. 2, the STA MLD 208-1 communicates with the AP MLD 204 through multiple communications links 202-1, 202-2, 202-3. For example, each of the STAs 210-1, 210-2, 210-3 communicates with an AP 206-1, 206-2, or 206-3 through a corresponding communications link 202-1, 202-2, or 202-3. In an embodiment, a communication link (e.g., the communications link 202-1, the communications link 202-2, or the communications link 202-3) may include a BSS operating channel established by an AP (e.g., the AP 206-1, the AP 206-2, or the AP 206-3) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the AP MLD 204 communicates (e.g., wirelessly communicates) with the STA MLD 208-1 through multiple links 202-1, 202-2, 202-3, in other embodiments, the AP MLD 204 may communicate (e.g., wirelessly communicate) with the STA MLD through more than three communications links or less three than communications links. The communications links in the multi-link communications system may include multiple mmWave links and one non-mmWave link, multiple mmWave links and multiple non-mmWave links, one mmWave link and multiple non-mmWave links, or one mmWave link and one non-mmWave link. For example, in the embodiment depicted in FIG. 1, the communications links 202-1, 202-2, 202-3 between the AP MLD 204 and the STA MLD 208-1 involve at least one mmWave link. For example, the communications links 202-1, 202-2, 202-3 between the AP MLD 204 and the STA MLD 208-1 include an mmWave link (e.g., a 45/60 GHz link) between an AP of the AP MLD 204 and an STA of the STA MLD 208-1 operating in an mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 204 and STAs of the STA MLD 208-1 operating in non-mmWave frequency bands (e.g., 2.4 GHz, 5 GHz, or 6 GHz frequency bands). In another example, the communications links 202-1, 202-2, 202-3 between the AP MLD 204 and the STA MLD 208-1 include two mmWave links (e.g., 45/60 GHz links) between APs of the AP MLD 204 and STAs of the STA MLD 208-1 operating in mmWave frequency bands (e.g., 45/60 GHz frequency bands) and one non-mmWave link (e.g., a 2.4 GHz, 5 GHz, or 6 GHz link) between an AP of the AP MLD 204 and an STA of the STA MLD 208-1 operating in a non-mmWave frequency bands (e.g., a 2.4 GHz, 5 GHz, or 6 GHz frequency band). The control and management of an mmWave link, for example, a 45 GHz/60 GHz link may be performed in a non-mmWave link, for example, a 2.4 GHz, 5 GHz, or 6 GHz link. For example, the association of a non-AP MLD with an mmWave link can be done or conducted through a non-mmWave MHz link. However, beaconing and channel switch can be challenging for a MLD system with one or more mmWave links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD through a non-mmWave link only. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol) in a non-mmWave link only with the following exception: a measurement management frame for an mmWave link can be transmitted in the mmWave link, or a management frame for an mmWave link after the mmWave link is established (i.e., the beam training of the mmWave link is finished) can be transmitted in the mmWave link. As an example, a cross-link management frame transmission may involve a management frame being transmitted and/or received on one link (e.g., the link 1 202-1) while carrying information of another link (e.g., the link 2 202-2) that is a non-mmWave link. In some embodiments, a management frame is transmitted on any link other than a non-mmWave link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

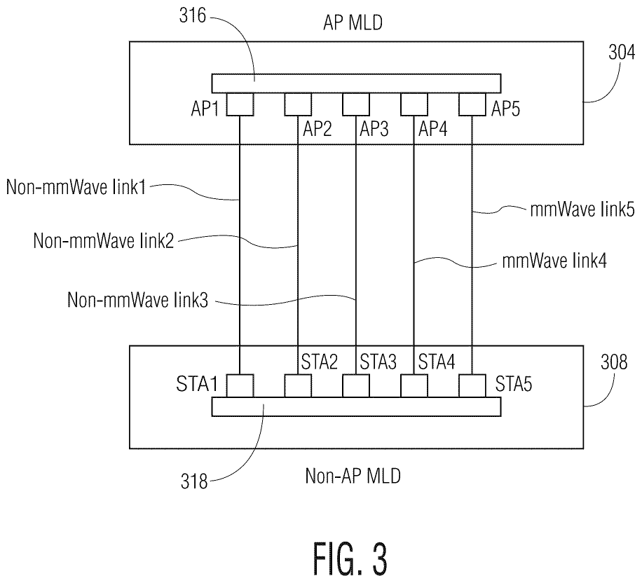

FIG. 3 depicts a multi-link (ML) communications system 300 in accordance with example embodiments. In the embodiment depicted in FIG. 3, the ML communications system 300 includes an AP MLD 304, which includes a common MAC controller 316 and five wireless APs AP1, AP2, AP3, AP4, AP5 and a non-AP MLD 308, which includes a common MAC controller 318 and five wireless STAs STA1, STA2, STA3, STA4, STA5. In some embodiments, the common MAC controller 316 implements upper layer MAC functionalities that are common the more than one link (e.g., association establishment, reordering of frames, etc.) of the AP MLD 304 and a link specific part of the AP MLD 304, i.e., AP1, AP2, AP3, AP4, AP5, implements the up layer MAC functionalities specific to a link and lower layer MAC functionalities (e.g., beaconing, backoff, frame transmission, frame reception, etc.) of the AP MLD 304. In some embodiments, the common MAC controller 318 implements upper layer MAC functionalities common to more than one link(e.g., association establishment, reordering of frames, etc.) of the non-AP MLD 304 and a link specific part of the non-AP MLD 308, i.e., STA1, STA2, STA3, STA4, STA5, implements upper layer functionalities specific to a link and lower layer MAC functionalities (e.g., backoff, frame transmission, frame reception, etc.) of the non-AP MLD 308. The ML communications system 300 depicted in FIG. 3 is an embodiment of the ML communications system 200 depicted in FIG. 2. However, the ML communications system 200 depicted in FIG. 2 is not limited to the embodiment shown in FIG. 3. For example, the AP MLD 304 depicted in FIG. 3 is an embodiment of the AP MLD 204 depicted in FIG. 2. However, the AP MLD 204 depicted in FIG. 2 is not limited to the embodiment shown in FIG. 3. In addition, the non-AP MLD 308 depicted in FIG. 3 is an embodiment of the non-AP MLDs 208-1, 208-2, 208-3 depicted in FIG. 2. However, the non-AP MLDs 208-1, 208-2, 208-3 depicted in FIG. 2 are not limited to the embodiment shown in FIG. 3. In the embodiment depicted in FIG. 3, a non-mmWave link (e.g., a 2.4/5/6 GHz band link), which is referred to as the non-mmWave link1, is between AP1 and STA1, which both operate in a non-mmWave frequency band (e.g., a 2.4 GHz, 5 GHz, or 6 GHz frequency band) and are capable of non-mmWave communications, a non-mmWave link (e.g., a 2.4/5/6 GHz band link), which is referred to as the non-mmWave link2, is between AP2 and STA2, which both operate in a non-mmWave frequency band (e.g., a 2.4 GHz, 5 GHz, or 6 GHz frequency band) and are capable of non-mmWave communications, an mmWave link (e.g., a 45 GHz IMMW link or a 60 GHz IMMW link), which is referred to the mmWave link3, is between AP3 and STA3, which both operate in an mmWave frequency band (e.g., a 45 GHz or 60 GHz frequency band) and are capable of mmWave communications, an mmWave link (e.g., a 45 GHz IMMW link or a 60 GHz IMMW link), which is referred to the mmWave link4, is between AP4 and STA4, which both operate in an mmWave frequency band (e.g., a 45 GHz or 60 GHz frequency band) and are capable of mmWave communications, and an mmWave link (e.g., a 45 GHz IMMW link or a 60 GHz IMMW link), which is referred to the mmWave link5, is between AP5 and STA5, which both operate in an mmWave frequency band (e.g., a 45 GHz or 60 GHz frequency band) and are capable of mmWave communications. Although the AP MLD 304 is shown in FIG. 3 as including five APs, other embodiments of the AP MLD 304 may include fewer than five APs or more than five APs. In addition, although the non-AP MLD 308 is shown in FIG. 3 as including five non-AP STAs, other embodiments of the non-AP MLD 308 may include fewer than five non-AP STAs or more than five non-AP STAs.

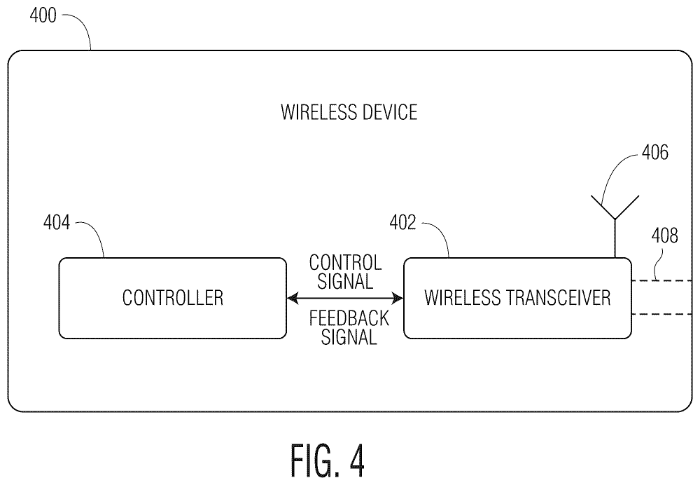

FIG. 4 depicts a wireless device 400 in accordance with an embodiment of the disclosure. The wireless device 400 can be used in the wireless communications system 100 depicted in FIG. 1, the multi-link communications system 200 depicted in FIG. 2, and/or the multi-link communications system 300 depicted in FIG. 3 for each link independently. For example, the wireless device 400 may be an embodiment of the AP 106 depicted in FIG. 1, the STA 110-1, . . . , 110-n depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3. In the embodiment depicted in FIG. 4, the wireless device 400 includes a wireless transceiver 402, a controller 404 operably connected to the wireless transceiver, and at least one antenna 406 operably connected to the wireless transceiver. In some embodiments, the wireless device 400 may include at least one optional network port 408 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 400 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 402 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the disclosure, the controller 404 is configured to perform a backoff procedure before a transmit opportunity (TXOP) for frame exchanges in an integrated millimeter wave (IMMW) link and to perform TXOP protection at a beginning of the TXOP, and the wireless transceiver 402 is configured to conduct the frame exchanges (for example, taking part in the operation or management of the frame exchanges, such as to transmit and receive frames) in the IMMW link during the TXOP, for example, through the at least one antenna 406.

In some embodiments, the controller 404 performs the backoff procedure (e.g., an Enhanced Distributed Channel Access (EDCA) backoff procedure) to reduce collisions by implementing a waiting period before the wireless device 400 (e.g., the wireless transceiver 402) attempts to retransmit data, with parameters that can be adjusted, for example, based on channel conditions and historical usage metrics. In some embodiments, the controller 404 implements a backoff timer, which freezes when a transmission is detected on the wireless medium/channel and resumes when the wireless medium/channel is detected as idle again, for example, for an arbitration Interframe Space (AIFS) interval. In some embodiments, when the backoff timer reaches zero or other predefined threshold value, the wireless device 400 (e.g., the wireless transceiver 402) transmits the packet(s) on the wireless medium/channel.

In some embodiments, the wireless device 400 includes an IMMW wireless access point (AP) associated with an AP multi-link device (MLD), and the IMMW link and at least another non-IMMW link are established between the AP MLD and a non-AP station (STA) MLD.

In some embodiments, the wireless device 400 includes an IMMW non-access point (AP) station (STA) associated with a non-AP STA multi-link device (MLD), and the IMMW link and at least another non-IMMW link are established between the non-AP STA MLD and an AP MLD.

In some embodiments, the backoff procedure in the IMMW link includes an Enhanced Distributed Channel Access (EDCA) backoff procedure. In some embodiments, a single access category (AC)'s backoff is used in the EDCA backoff procedure.

In some embodiments, the controller 404 is further configured to define a single network allocation vector (NAV) timer for a virtual carrier sensing of the EDCA backoff procedure in the IMMW link.

In some embodiments, the controller 404 is further configured to define a duplicate Physical Layer Protocol Data Unit (PPDU) to perform the TXOP protection.

In some embodiments, a request to send (RTS) and a clear to send (CTS), a multi-user (MU)-RTS and CTS, or a Buffer Status Report polling (BSRP) non-trigger based (NTB) frame and a Multi-station (STA) block acknowledgement (BA) at a beginning of the TXOP for the TXOP protection are carried in the duplicate PPDU.

In some embodiments, a request to send (RTS) and a clear to send (CTS) for the TXOP protection are carried in the duplicate PPDU.

In some embodiments, an acknowledgment (Ack) and a block Ack (BA) for the TXOP protection are carried in the duplicate PPDU to acknowledge a soliciting MAC Protocol Data Unit (MPDU) and an Aggregated MAC Protocol Data Unit (A-MPDU), respectively.

In some embodiments, frame exchanges between an IMMW access point (AP) and an IMMW station (STA) are within a negotiated service period (SP), and the frame exchanges ends at an end time of the negotiated SP or before the end time of the negotiated SP if there is no further frame to transmit and receive. In some embodiments, only one of the AP and the STA as the member of a negotiation SP can perform the backoff in the SP.

In some embodiments, outside a service period (SP), an IMMW access point (AP) and an IMMW station (STA) are not available.

In some embodiments, after the IMMW AP or the IMMW STA becomes available, the IMMW AP or the IMMW STA monitors a wireless medium for a pre-defined time, and if the wireless medium is idle within the predefined time, the IMMW AP or the IMMW STA starts to count down its backoff counter.

In some embodiments, a TXOP field carrying a remaining time of the TXOP in a physical layer (PHY) header is not set to UNSPECIFIED when a Basic Service Set (BSS) color collision occurs.

In some embodiments, the IMMW link includes a 45 Gigahertz (GHz) link or a 60 GHz link.

In some embodiments, the wireless device 400 is compatible with an Institute of Electrical and Electronics Engineers (IEEE) 802.11 protocol.

In some embodiments, a wireless access point (AP) in an integrated millimeter wave (IMMW) link affiliated with an AP multi-link device (MLD) includes a controller configured to perform an Enhanced Distributed Channel Access (EDCA) backoff procedure before a transmit opportunity (TXOP) for frame exchanges in the IMMW link and to perform TXOP protection at a beginning of the TXOP and a wireless transceiver configured to conduct the frame exchanges in the IMMW link with a STA in the IMMW link affiliated with the non-AP station (STA) MLD during the TXOP.

Some implementations of frames in Integrated MilliMeter Wave (IMMW) Link, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, after an IMMW link is established (i.e., a beam sector is selected after beam training), the responding frames to acknowledge quality of service (QoS) Data frame(s) or Management frames in the IMMW link are transmitted in the IMMW link.

In some embodiments, after the IMMW link is established (i.e., a beam sector is selected after beam training), the control frame exchange to protect the Transmit Opportunity (TXOP) of IMMW link is done or conducted in the IMMW link.

In some embodiments, an mmWave AP transmits Null Data Packet (NDP) Beacon frames at target beacon transmission time (TBTT) in an IMMW link or per request through a 7 GHz or lower (<=7 GHz) (non-IMMW) link.

In some embodiments, the control frame handshake to initiate the beam recovery or fine beam training can be exchanged in an IMMW link.

In some embodiments, the control frame handshake for NDP frame exchanges of IMMW link establishment (sector selection) is done or conducted in a non-IMMW link.

Some implementations of general rules of an IMMW frame exchange, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, no control physical layer (PHY) PPDU exists where the control PHY PPDU can reach a peer device in an omni receiving mode.

In some embodiments, the on-demand service period (SP) in an IMMW link can be established for the frame exchanges in the IMMW link. In some embodiments, the handshake for the on-demand service period (SP) establishment is done or conducted in a 7 GHz or lower (<=7 GHz, i.e., non-IMMW) link.

In some embodiments, the periodic service periods using individual Target Wake Time (TWT) (ITWT) or broadcast TWT (BTWT) in the IMMW link can be established for the frame exchanges in the IMMW link. In some embodiments, the handshake for the TWT establishment is done or conducted in a 7 GHz or lower (<=7 GHz) link.

Some implementations of ITWT based frame exchange, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, a STA in an IMMW link affiliated with a non-AP MLD negotiates the ITWT agreement of the IMMW link with the AP in the IMMW link affiliated with its associated AP MLD through a 7 GHz or lower (<=7 GHz) link.

In some embodiments, at the start time of the negotiated IMMW ITWT service period (SP), the IMMW STA (a non-AP STA in the IMMW link) does or conducts the frame exchanges using its receive/transmit beam decided through a sounding procedure with the IMMW AP (an AP in the IMMW link) until the end of the IMMW ITWT SP.

In some embodiments, at the start time of the negotiated IMMW ITWT SP of an IMMW STA, the associated IMMW AP does or conducts the frame exchanges using its receive/transmit beam decided through a sounding procedure with the IMMW STA until the end of the IMMW ITWT SP.

In some embodiments, an AP can announce STA's backoff being allowed in one IMMW STA's ITWT SP when negotiating the ITWT SP if such ITWT SP does not overlap with another IMMW STA's ITWT SP and both the AP and the STA support reciprocal operation (i.e., use the same antenna pattern for transmitting the frames to and receive the frames from a peer device, have the transmitter (Tx) beam same as the receiver (Rx) beam). In some embodiments, an AP can announce STA's backoff being allowed in one IMMW STA's ITWT SP when negotiating the ITWT SP if both the AP and the STA support reciprocal operation.

In some embodiments, an AP can announce STA's backoff being disallowed in one IMMW STA's ITWT SP when at least one of the AP and the STA does not support reciprocal operation. In some embodiments, the AP can do or perform the TXOP sharing with the STA, i.e., the AP allocates its TXOP time to the STA, e.g., through MU-RTS TXS (TXOP sharing) or the other method, where the STA transmits its uplink (UL) data frames to the AP within the TXOP time allocated by the AP.

Some implementations of Broadcast Target Wake Time (BTWT) based frame exchange, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, a STA in an IMMW link affiliated with a non-AP MLD negotiates the BTWT membership agreement of the IMMW link with the AP in the IMMW link affiliated with its associated AP MLD through a 7 GHz or lower (<=7 GHz) link.

In some embodiments, at the start time of the negotiated IMMW BTWT SP, the IMMW STA (non-AP STA in IMMW link) does or conducts the frame exchanges using its receive/transmit beam decided through a sounding procedure with the IMMW AP (AP in IMMW link) until the end of IMMW ITWT SP.

In some embodiments, at the start time of the negotiated IMMW BTWT SP of an IMMW STA, the associated IMMW AP does or conducts the frame exchanges using its receive/transmit beam decided through a sounding procedure with the IMMW STA until the end of IMMW ITWT SP.

In some embodiments, in a BTWT SP, a STA's Enhanced Distributed Channel Access (EDCA) is disallowed unless different STAs are allocated to at least one different service period in a broadcast TWT SP. In some embodiments, the AP can do or perform the TXOP sharing with the STA, i.e., the AP allocates its TXOP time to the STA, for example, through MU-RTS TXS or the other method, where the STA transmits its UL data frames to the AP within the TXOP time allocated by the AP.

In some embodiments, the medium time allocation of a BTWT SP by an IMMW AP to an IMMW STA is executed in the TXOP using a control frame handshake.

In some embodiments, the medium time allocation is done or conducted through a control frame handshake, e.g., an updated multi-user (MU)-request to send (RTS) TXS and clear to send (CTS) or a new defined control frame exchange (buffer status report poll (BSRP) and Multi-STA Block Ack (BA)).

Some implementations of Frame Exchanges through On-demand SP, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, an IMMW AP may initiate frame exchanges with an IMMW STA within an on-demand IMMW SP. In some embodiments, the IMMW AP notifies its intention of frame exchange with the IMMW STA through a 7 GHz or lower (<=7 GHz) link. In some embodiments, the Initial Control Frame (ICF), Initial Control Response (ICR) in a 7 GHz or lower (<=7 GHz) link can be used or designed for such negotiation. In some embodiments, an ICF carries the start time, actives the duration that defines the on-demand SP. In some embodiments, the default case is the frame exchanges in an IMMW link is right after the negotiation of ICF, ICR. In some embodiments, an ICR carries the agreed start time and the duration that may be different from the requested start time and a TXOP duration. In some embodiments, in one variant, the STA always accepts the AP's start time and active duration.

In some embodiments, at the agreed start time, the associated IMMW AP does or conducts the frame exchanges using its receive/transmit beam decided through a sounding procedure with the IMMW STA until the end of the TXOP. In some embodiments, in one variant, if/when the medium is busy at the beginning of an on-demand SP, the SP duration will be updated accordingly. In some embodiments, the AP can decide whether the SP extension is allowed or not.

In some embodiments, at the agreed start time, the IMMW STA (STA in IMMW link) does or conducts the frame exchanges using its receive/transmit beam decided through a sounding procedure with the IMMW AP (AP in IMMW link) until the end of the TXOP. In some embodiments, in one variant, if/when the medium is busy at the beginning of on-demand SP, the SP duration will be updated accordingly. In some embodiments, the AP can decide whether the SP extension is allowed or not.

Some implementations of EDCA Backoff in an IMMW link, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, an mmWave AP announces EDCA parameters through a non-IMMW link.

In some embodiments, an IMMW AP does or performs backoff before a TXOP. In some embodiments, each AP has one network allocation vector (NAV) timer.

In some embodiments, a non-AP IMMW STA does or performs backoff before a TXOP if allowed by the IMMW AP. In some embodiments, in Option 1, each non-AP STA has one NAV timer. In some embodiments, in Option 2, each non-AP STA has one basic NAV timer and one intra-BSS NAV timer.

Some implementations of TXOP Protection, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, a duplicate PPDU is defined with each PPDU covers the narrowest bandwidth (BW) of an IMMW link, e.g., 160 MHz. In some embodiments, the duplicate PPDU can be one PPDU in BW of 160 MHz, two PPDUs in BW of 320 MHz, or four PPDUs in BW of 640 MHz.

In some embodiments, the TXOP can be protected by the RTS/CTS exchange at the beginning of the TXOP in duplicate PPDU. In some embodiments, MU-RTS/CTS is not allowed.

In some embodiments, static and dynamic BW negotiation are allowed.

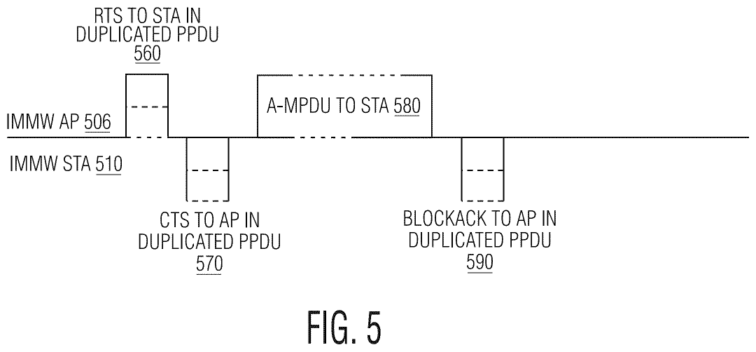

FIG. 5 illustrates an exchange in duplicate PPDUs in accordance with example embodiments. As illustrated in FIG. 5, an IMMW AP 506 transmits an RTS 560 in duplicate/duplicated PPDUs, e.g., with each PPDU equal to 320 MHz and the duplicate PPDUs equal to 640 MHz, to an IMMW STA 510, the IMMW STA 510 transmits a CTS 570 in duplicate/duplicated PPDUs, e.g., with each PPDU equal to 320 MHz and the duplicate PPDUs equal to 640 MHz, to the IMMW AP 506, the IMMW AP 506 transmits an A-MPDU (Aggregate MAC Protocol Data Unit) 580, e.g., in a PPDU equal to 640 MHz, to the IMMW STA 510, and the IMMW STA 510 transmits a block acknowledgement (Ack) 590 in duplicate/duplicated PPDUs, e.g., with each PPDU equal to 320 MHz and the duplicate PPDUs equal to 640 MHz, to the IMMW AP 506. The IMMW AP 506 may be the same as or similar to an embodiment of the AP 106 in an IMMW link depicted in FIG. 1, the APs 206-1, 206-2, 206-3 in an IMMW link depicted in FIG. 2, the APs AP1, AP2, AP3, AP4, AP5 in an IMMW link depicted in FIG. 3, and/or the wireless device 400 depicted in FIG. 4. The IMMW STA 510 may be the same as or similar to an embodiment of the STA 110-1, . . . , or 110-n in an IMMW link depicted in FIG. 1, the STAs 210-1, 210-2, 210-3 in an IMMW link depicted in FIG. 2, the STAs STA1, STA2, STA3, STA4, STA5 in an IMMW link depicted in FIG. 3, and/or the wireless device 400 depicted in FIG. 4.

Some implementations of a responding PPDU, for example, by the STA/AP in the wireless communications system 100 depicted in FIG. 1, the APs 206-1, 206-2, 206-3 in an IMMW link depicted in FIG. 2, the STAs 210-1, 210-2, 210-3 in an IMMW link depicted in FIG. 2, the APs AP1, AP2, AP3, AP4, AP5 in an IMMW link depicted in FIG. 3, and/or the STAs STA1, STA2, STA3, STA4, STA5 in an IMMW link depicted in FIG. 3, and/or the wireless device 400 depicted in FIG. 4 are described.

In some embodiments, a responding frame is carried in a duplicate PPDU such that a third-party STA can detect the Duration field in a MAC header of the responding frame. Justification of such operation may be that the Duration field provide more accurate remaining time of a TXOP then the TXOP field in the PHY header.

Some implementations of TXOP Field in PHY signal (SIG), for example, by the STA/AP in the wireless communications system 100 depicted in FIG. 1, the APs 206-1, 206-2, 206-3 in an IMMW link depicted in FIG. 2, the STAs 210-1, 210-2, 210-3 in an IMMW link depicted in FIG. 2, the APs AP1, AP2, AP3, AP4, AP5 in an IMMW link depicted in FIG. 3, and/or the STAs STA1, STA2, STA3, STA4, STA5 in an IMMW link depicted in FIG. 3, and/or the wireless device 400 depicted in FIG. 4 are described.

In some embodiments, in Option 1, the TXOP field in the PHY SIG indicate the remaining of the TXOP even if the BSS color collision happens or occurs. The justification for this option is that no uplink (UL) trigger-based (TB) PPDU is supported.

In some embodiments, in Option 2, the TXOP field in the PHY SIG indicates the remaining of the TXOP if the BSS color collision does not happen. Otherwise, the TXOP filed in PHY SIG indicates UNSPECIFIED. The justification for this option is that in the future the UL TB PPDU may be supported.

Some implementations of IMMW AP Power Save, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, the frame exchanges between an IMMW AP and IMMW STAs are only performed within individual TWT (Target Wake Time) service periods (SPs), broadcast TWT SPs and on-dement SPs negotiated between the IMMW AP and an IMMW STA or announced by the IMMW AP for a SP with multiple IMMW STAs as the SP members. In some embodiments, only one of the AP and the STA as the member of a negotiation SP can perform the backoff in the SP. In some embodiments, the ICF (BSRP non-trigger based (NTB)) and ICR (Multi-STA BA) are used for on-demand SP negotiation where one ICF/ICR handshake negotiate one on-demand SP. In some embodiments, in Option 1, outside the negotiated IMMW ITWT SP, BTWT SP, on-demand SP, an IMMW AP is in a power save mode and a doze state. In some embodiments, at the start of the negotiated SP with an IMMW STA, the IMMW AP is in an awake state until the end of the TWT SP or earlier than the end of the SP when there are no downlink (DL) frames, UL frames that need to be transmitted/received.

In some embodiments, in Option 2, outside the negotiated IMMW ITWT SP, BTWT SP, on-demand SP, an IMMW AP is unavailable. In some embodiments, at the start of the negotiated SP with an IMMW STA, the AP is available for frame exchanges until the end of the SP or earlier than the end of the SP when there are no DL frames, UL frames that need to be transmitted/received.

Some implementations of IMMW STA Power Save, for example, by the STA/AP in the wireless communications system 100 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4 are described.

In some embodiments, in Option 1, outside the negotiated IMMW ITWT SP, BTWT SP, on-demand SP, an IMMW non-AP STA is in a power save mode and a doze state. In some embodiments, at the start of the negotiated SP with an IMMW STA, the non-AP STA is in an awake state until the end of the TWT SP or earlier than the end of the SP when there are no UL frames, DL frames that need to be transmitted/received.

In some embodiments, in Option 2, outside the negotiated IMMW ITWT SP, BTWT SP, on-demand SP, the IMMW AP is unavailable. In some embodiments, at the start of the negotiated SP with an IMMW STA, the IMMW non-AP STA is available for frame exchanges until the end of the TWT SP or earlier than the end of the SP when there are no DL frames, UL frames that need to be transmitted.

In some embodiments, a method of supporting frame exchanges in IMMW link between a first device in an IMMW link and a second device involves doing/performing, by the device in the IMMW link, the backoff through EDCA procedure for the frame exchanges in the IMMW link, protecting, by the device, the frame exchanges at the beginning of the TXOP, performing, between the first and second device, the frame exchanges in the IMMW link within the TXOP. In some embodiments, the EDCA procedure only uses a single AC to perform the backoff. In some embodiments, the Distributed coordination function (DCF) procedure is used for the backoff in the IMMW link. In some embodiments, after an IMMW AP/STA becomes available or switches to an awake state, the IMMW AP/STA monitors the wireless medium for a predefined time that is used for the medium synchronization (NAV (Network Allocation Vector) timer synchronization). In some embodiments, the predefined time is Point Coordination Function (PCF) Interframe Space (PIFS), DCF interframe space (DIFS), Arbitration interframe space (AIFS) or a longer time than PIFS/AIFS. In some embodiments, the predefined time is announced by the AP. In some embodiments, the IMMW AP/STA starts to count down its backoff counter value if the medium within the predefined time after it switched to available is idle. In some embodiments, a single NAV timer is defined for the virtual carrier sensing of the EDCA backoff. In some embodiments, the duplicate PPDU is defined. In some embodiments, the RTS and CTS, or MU-RTS and CTS for the TXOP protection are carried in the duplicate PPDU at the beginning of the TXOP. In some embodiments, the BSRP NTB and Multi-STA BA for the TXOP protection are carried in the duplicate PPDU. In some embodiments, the carrier sense (CS) Required in BSRP NTB is always set to 0. In some embodiments, the Multi-STA BA is used to indicate that the TXOP responder is not available. In some embodiments, the Ack and BA are carried in duplicate PPDU. In some embodiments, the TXOP field carrying the remaining time of the TXOP in the PHY header is not set to UNSPECIFIED when a BSS color collision happens.

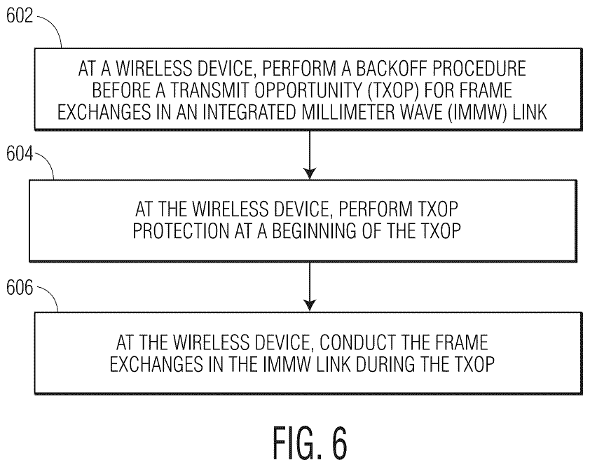

FIG. 6 is a process flow diagram of a method for wireless communications in accordance with example embodiments. At block 602, at a wireless device, a backoff procedure is performed before a transmit opportunity (TXOP) for frame exchanges in an integrated millimeter wave (IMMW) link. At block 604, at the wireless device, TXOP protection and soliciting peer device's availability are performed at a beginning of the TXOP by exchanging (MU-)RTS and CTS or exchanging BSRP NTB and Multi-STA BA. In some embodiments, at the wireless device, TXOP protection and soliciting peer device's availability are performed at a beginning of the TXOP by exchanging (MU-)RTS and CTS or exchanging BSRP NTB and Multi-STA BA. At block 606, at the wireless device, the frame exchanges are conducted in the IMMW link during the TXOP. In some embodiments, the wireless device includes an IMMW wireless access point (AP) associated with an AP multi-link device (MLD), and the IMMW link is established between the AP MLD and a non-AP station (STA) MLD. In some embodiments, the wireless device includes an IMMW non-access point (AP) station (STA) associated with a non-AP STA multi-link device (MLD), and the IMMW link is established between the non-AP STA MLD and an AP MLD. In some embodiments, the backoff procedure includes an Enhanced Distributed Channel Access (EDCA) backoff procedure. In some embodiments, a single access category (AC)'s backoff is used in the EDCA backoff procedure. In some embodiments, at the wireless device, a single network allocation vector (NAV) timer is defined for a virtual carrier sensing of the EDCA backoff procedure. In some embodiments, at the wireless device, a duplicate Physical Layer Protocol Data Unit (PPDU) is defined to perform the TXOP protection. The wireless device may be the same as or similar to an embodiment of the STA 110-1, . . . , or 110-n and/or the AP 106 depicted in FIG. 1, the APs 206-1, 206-2, 206-3 depicted in FIG. 2, the STAs 210-1, 210-2, 210-3 depicted in FIG. 2, the APs AP1, AP2, AP3, AP4, AP5 depicted in FIG. 3, and/or the STAs STA1, STA2, STA3, STA4, STA5 depicted in FIG. 3, and/or the wireless device 400 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the claims is to be defined by the claim language and their equivalents.

What is claimed is:

1. A wireless device comprising:
a controller configured to perform a backoff procedure before a transmit opportunity (TXOP) for a plurality of frame exchanges in an integrated millimeter wave (IMMW) link and to perform TXOP protection at a beginning of the TXOP; and
a wireless transceiver configured to conduct the frame exchanges in the IMMW link during the TXOP.

2. The wireless device of claim 1, wherein the wireless device comprises an IMMW wireless access point (AP) associated with an AP multi-link device (MLD), and wherein the IMMW link is established between the AP MLD and a non-AP station (STA) MLD.

3. The wireless device of claim 1, wherein the wireless device comprises an IMMW non-access point (AP) station (STA) associated with a non-AP STA multi-link device (MLD), and wherein the IMMW link is established between the non-AP STA MLD and an AP MLD.

4. The wireless device of claim 1, wherein the backoff procedure comprises an Enhanced Distributed Channel Access (EDCA) backoff procedure.

5. The wireless device of claim 4, wherein a single access category (AC)'s backoff is used in the EDCA backoff procedure.

6. The wireless device of claim 5, wherein the controller is further configured to define a single network allocation vector (NAV) timer for a virtual carrier sensing of the EDCA backoff procedure.

7. The wireless device of claim 1, wherein the controller is further configured to define a duplicate Physical Layer Protocol Data Unit (PPDU) to perform the TXOP protection.

8. The wireless device of claim 7, wherein a request to send (RTS) and a clear to send (CTS), a multi-user (MU)-RTS and CTS, or a Buffer Status Report polling (BSRP) non-trigger based (NTB) frame and a Multi-station (STA) block acknowledgement (BA) at a beginning of the TXOP for the TXOP protection are carried in the duplicate PPDU.

9. The wireless device of claim 7, wherein an acknowledgment (Ack) and a block Ack (BA) for the TXOP protection are carried in the duplicate PPDU to acknowledge a soliciting MAC Protocol Data Unit (MPDU) and an Aggregated MAC Protocol Data Unit (A-MPDU), respectively.

10. The wireless device of claim 1, wherein a plurality of frame exchanges between an IMMW access point (AP) and an IMMW station (STA) are within a negotiated service period (SP), and wherein the frame exchanges ends at an end time of the negotiated SP or before the end time of the negotiated SP if there is no further frame to transmit and receive.

11. The wireless device of claim 1, wherein outside a service period (SP), an IMMW access point (AP) and an IMMW station (STA) are not available.

12. The wireless device of claim 11, wherein after the IMMW AP or the IMMW STA becomes available, the IMMW AP or the IMMW STA monitors a wireless medium for a pre-defined time, and wherein if the wireless medium is idle within the pre-defined time, the IMMW AP or the IMMW STA starts to count down its backoff counter.

13. A wireless access point (AP) multi-link device (MLD) comprising:
a controller configured to perform an Enhanced Distributed Channel Access (EDCA) backoff procedure before a transmit opportunity (TXOP) for a plurality of frame exchanges in an integrated millimeter wave (IMMW) link and to perform TXOP protection at a beginning of the TXOP; and
a wireless transceiver configured to conduct the frame exchanges in the IMMW link with a non-AP station (STA) MLD during the TXOP.

14. A method for wireless communications, the method comprising:
at a wireless device, performing a backoff procedure before a transmit opportunity (TXOP) for a plurality of frame exchanges in an integrated millimeter wave (IMMW) link;
at the wireless device, performing TXOP protection at a beginning of the TXOP; and
at the wireless device, conducting the frame exchanges in the IMMW link during the TXOP.

15. The method of claim 14, wherein the wireless device comprises an IMMW wireless access point (AP) associated with an AP multi-link device (MLD), and wherein the IMMW link is established between the AP MLD and a non-AP station (STA) MLD.

16. The method of claim 14, wherein the wireless device comprises an IMMW non-access point (AP) station (STA) associated with a non-AP STA multi-link device (MLD), and wherein the IMMW link is established between the non-AP STA MLD and an AP MLD.

17. The method of claim 14, wherein the backoff procedure comprises an Enhanced Distributed Channel Access (EDCA) backoff procedure.

18. The method of claim 17, wherein a single access category (AC)'s backoff is used in the EDCA backoff procedure.

19. The method of claim 18, wherein performing the backoff procedure comprises at the wireless device, defining a single network allocation vector (NAV) timer for a virtual carrier sensing of the EDCA backoff procedure.

20. The method of claim 14, wherein performing the TXOP protection comprises at the wireless device, defining a duplicate Physical Layer Protocol Data Unit (PPDU) to perform the TXOP protection.
